(19) United States
(12) Patent Application Publication
(10) Pub. No.: US 2019/0171977 A1
(43) Pub. Date: Jun. 6, 2019

(54) Using Machine Learning System to Dynamically Process Events

(71) Applicant: Bank of America Corporation, Charlotte, NC (US)

(72) Inventors: Manu Kurian, Dallas, TX (US); Matthew E. Carroll, Charlotte, NC (US)

(21) Appl. No.: 15/833,049

(22) Filed: Dec. 6, 2017

(51) Int. Cl. G06N 99/00

(52) U.S. Cl. CPC G06N 99/005; G06Q 20/3278

(57) ABSTRACT

Systems for dynamically processing events are provided. In some examples, a system may receive a request to process an event. The request may be received from, for example, a mobile device of a user. In some arrangements, location data associated with the mobile device may be received. Additional data, such as event details, may also be received. In some arrangements, one or more machine learning datasets may be used to identify one or more sources from which to process the requested event based on the received request, location data, additional data, and the like. In some examples, the event may be processed from the identified source automatically. A notification may also be generated and transmitted to the mobile device including details of the event, source from which the event was processed, and the like.

### BACKGROUND

Aspects of the disclosure relate to electrical computers, systems, and machine learning. In particular, one or more aspects of the disclosure relate to using machine learning to process events.

Processing events quickly, efficiently, and accurately important when considering the variety of event processing options available today. For instance, mobile or online event processing options often provide more convenience and flexibility thank traditional event processing options. However, it would be advantageous to use machine learning to identify one or more sources from which to process an event to provide greater flexibility, improved efficiency and greater accuracy.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with processing events.

In some examples, a system, computing platform, or the like, may receive a request to process an event. The request may be received from, for example, a mobile device of a user. In some arrangements, location data associated with the mobile device may be received. In some examples, additional data such as event details may also be received. In some arrangements, one or more machine learning datasets may be used to identify one or more sources from which to process the requested event based on the received request, location data, additional data, and the like.

In some examples, the event may be processed from the identified source automatically (e.g., without additional user input, interaction, or the like). A notification may also be generated and transmitted to the mobile device including details of the event, source from which the event was processed, and the like.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing dynamic event processing functions in accordance with one or more aspects described herein;

FIGS. 2A-2C depict an illustrative event sequence for implementing dynamic event processing functions in accordance with one or more aspects described herein;

FIG. 3 depicts an illustrative method for implementing and using a system to perform dynamic event processing functions, according to one or more aspects described herein;

FIG. 4 illustrates another illustrative method for implementing and using a system to perform dynamic event processing functions, according to one or more aspects described herein;

FIG. 5 illustrates an example user interface that may be generated, according to one or more aspects described herein;

FIG. 6 illustrates one example operating environment in which various aspects of the disclosure may be implemented in accordance with one or more aspects described herein; and

FIG. 7 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to using machine learning to identify a source to be used in processing an event. In some examples, two or more sources may be identified and/or used in processing the event.

As mentioned above, efficiently and accurately processing events is an important aspect of business today. Accordingly, aspects described herein provide for dynamic event processing based on, for example, machine learning. In some examples, machine learning datasets may be generated linking previous historical events or requests for event processing (e.g., via a device, such as an event processing device) with a location of a user, date, time, type of event, or the like. The machine learning datasets may be used to predict an appropriate source to use to process an event when an event request is received.

For instance, a user may request to process an event via, for example, a mobile event processing application executing on a mobile device. The request may be transmitted to a dynamic event processing computing platform. Additional data, such as location of the mobile device, event details, social media information, calendar information, and the like, may also be received. The one or more machine learning datasets may then be used to identify a source from which to process the requested event (e.g., based on the received data). In some examples, two or more sources may be identified and the system may identify a portion of the event to process from a first source and a portion to process from a second source.

In some arrangements, the event may be processed using the identified one or more sources automatically (e.g., without user interaction, input, or the like). In some examples, user input may be requested approving the event, identified one or more sources, and the like, prior to processing the event.

In some examples, a notification may be generated and transmitted to the mobile device for display. The notification may include an indication that the event was processed, an amount of the event, a source from which the event was processed, and the like.

These and various other arrangements will be discussed more fully below.

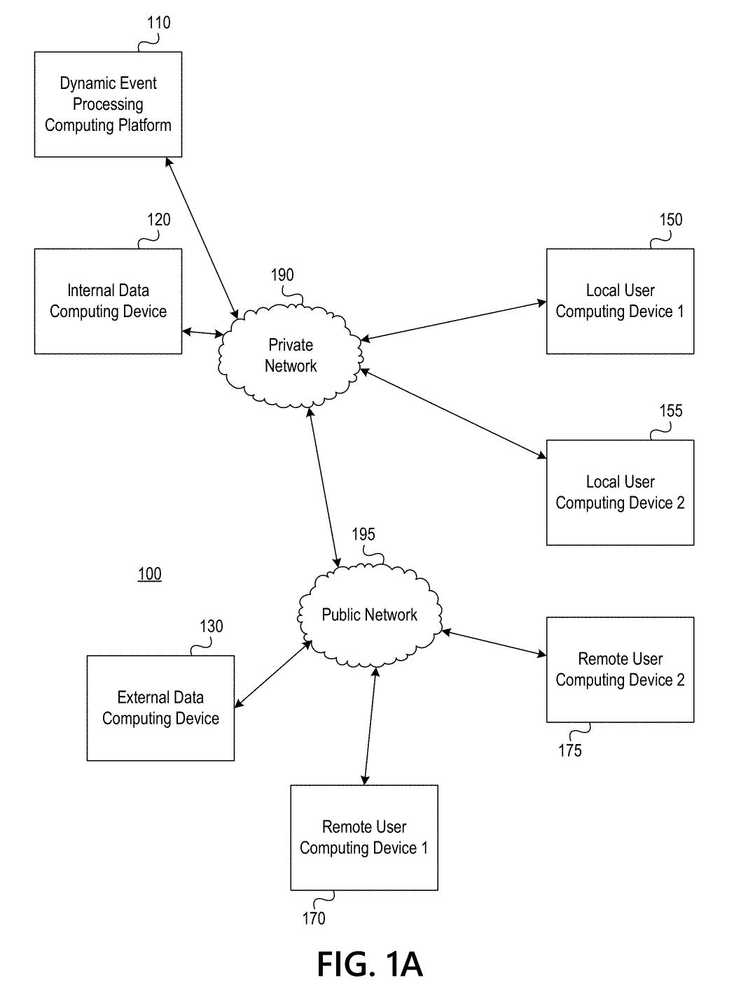

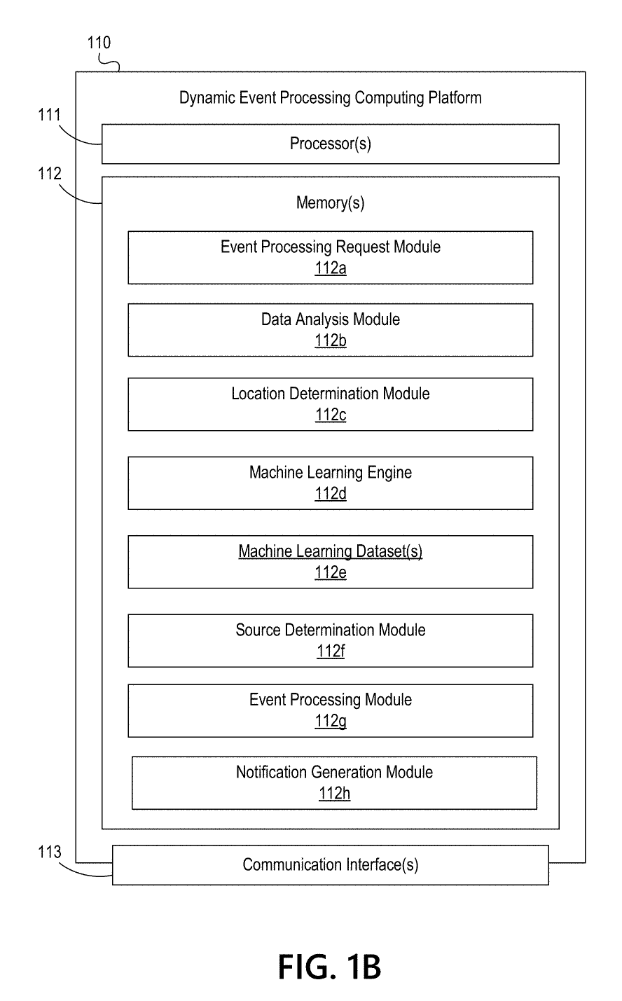

FIGS. 1A and 1B depict an illustrative computing environment for implementing and using a system for dynamically processing events in accordance with one or more aspects described herein. Referring to FIG. 1A, computing environment 100 may include one or more computing devices and/or other computing systems. For example, computing environment 100 may include a dynamic event processing computing platform 110, an internal data computing device 120, an external data computing device 130, a first local user computing device 150, a second local user computing device 155, a first remote user computing device 170, and a second remote user computing device 175.

Dynamic event processing computing platform 110 may be configured to host and/or execute a machine learning engine to provide dynamic event processing functions. In some examples, a request to process an event may be received from one or more devices, such as remote user computing device 170, remote user computing device 175. In some examples, remote user computing device 170, remote user computing device 175, or the like, may include a user computing device such as a smartphone, tablet, wearable device, or other mobile device having an on-line or mobile event processing application executing on the device. In some examples, the on-line or mobile application may be downloaded or otherwise provided to the device to enable event processing functionality, such as mobile payment.

Upon receiving the request to process the event, the dynamic event processing computing platform 110 may receive additional data, such as a location of a device associated with a user requesting event processing, details of the event, and the like. The additional data may be processed and, using machine learning, a source from which the event should be processed may be identified. In some examples, multiple sources may be identified. The event may then be processed.

Internal data computing device 120 may be configured to store, transmit, and/or receive data associated with one or more internal data or computer systems. For instance, an entity implementing the dynamic event processing computing platform 110 may store data associated with various users, event processing device parameter information, account information, historical transaction or other user data, user behavioral information associated with a device, and the like. This information may be transmitted, via the internal data computing device 120, to the dynamic event processing computing platform 110 and may be used to generate one or more machine learning datasets, identify a source to process an event, update and/or validate one or more machine learning datasets, and the like.

External data computing device 130 may be configured to store, transmit, and/or receive data associated with one or more data or computer systems external to the entity implementing the dynamic event processing computing platform 110. For instance, data, such as publicly available data, transaction or event details or data, user demographic data, social media data, vehicle sensor data, and the like, may be transmitted, via the external data computing device 130, from one or more data or computer systems, to the dynamic event processing computing platform 110 and may be used to generate one or more machine learning datasets, identify a source to process an event, update and/or validate one or more machine learning datasets, and the like.

Local user computing device 150, 155 and remote user computing device 170, 175 may be configured to communicate with and/or connect to one or more computing devices or systems shown in FIG. 1A. For instance, local user computing device 150, 155 may communicate with one or more computing systems or devices via network 190, while remote user computing device 170, 175 may communicate with one or more computing systems or devices via network 195. In some examples, local user computing device 150, 155 may be used to control or implement aspects of the functions performed by dynamic event processing computing platform 110, to provide source information to dynamic event processing computing platform 110, to aid in processing events, and the like.

The remote user computing devices 170, 175 may be used to communicate with, for example, dynamic event processing computing platform 110, transmit requests for event processing (e.g., via a mobile or online event processing application executing on the device), provide location information associated with the device (e.g., via a Global Positioning System (GPS) of the device, receive and display notifications, and the like.

In one or more arrangements internal data computing device 120, external data computing device 130, local user computing device 150, local user computing device 155, remote user computing device 170, and/or remote user computing device 175 may be any type of computing device or combination of devices capable of performing the particular functions described herein. For example, internal data computing device 120, external data computing device 130, local user computing device 150, local user computing device 155, remote user computing device 170, and/or remote user computing device 175 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of internal data computing device 120, external data computing device 130, local user computing device 150, local user computing device 155, remote user computing device 170, and/or remote user computing device 175 may, in some instances, be special-purpose computing devices configured to perform specific functions.

Computing environment 100 also may include one or more computing platforms. For example, and as noted above, computing environment 100 may include dynamic event processing computing platform 110. As illustrated in greater detail below, dynamic event processing computing platform 110 may include one or more computing devices configured to perform one or more of the functions described herein. For example, dynamic event processing computing platform 110 may include one or more computers (e.g., laptop computers, desktop computers, servers, server blades, or the like).

As mentioned above, computing environment 100 also may include one or more networks, which may interconnect one or more of dynamic event processing computing platform 110, internal data computing device 120, external data computing device 130, local user computing device 150, local user computing device 155, remote user computing device 170, and/or remote user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, dynamic event processing computing platform 110, internal data computing device 120, local user computing device 150, and local user computing device 155, may be associated with an organization (e.g., a financial institution), and private network 190 may be associated with and/or operated by the organization, and may include one or more networks (e.g., LANs, WANs, virtual private networks (VPNs), or the like) that interconnect dynamic event processing computing platform 110, internal data computing device 120, local user computing device 150, and local user computing device 155, and one or more other computing devices and/or computer systems that are used by, operated by, and/or otherwise associated with the organization. Public network 195 may connect private network 190 and/or one or more computing devices connected thereto (e.g., dynamic event processing computing platform 110, internal data computing device 120, local user computing device 150, local user computing device 155) with one or more networks and/or computing devices that are not associated with the organization. For example external data computing device 130, remote user computing device 170, and/or remote user computing device 175 might not be associated with an organization that operates private network 190 (e.g., because external data computing device 130, remote user computing device 170 and remote user computing device 175 may be owned, operated, and/or serviced by one or more entities different from the organization that operates private network 190, such as one or more customers of the organization, public or government entities, and/or vendors of the organization, rather than being owned and/or operated by the organization itself or an employee or affiliate of the organization), and public network 195 may include one or more networks (e.g., the internet) that connect external data computing device 130, remote user computing device 170 and remote user computing device 175 to private network 190 and/or one or more computing devices connected thereto (e.g., dynamic event processing computing platform 110, internal data computing device 120, local user computing device 150, local user computing device 155).

Referring to FIG. 1B, dynamic event processing computing platform 110 may include one or more processors 111, memory 112, and communication interface 113. A data bus may interconnect processor(s) 111, memory 112, and communication interface 113. Communication interface 113 may be a network interface configured to support communication between dynamic event processing computing platform 110 and one or more networks (e.g., private network 190, public network 195, or the like). Memory 112 may include one or more program modules having instructions that when executed by processor(s) 111 cause dynamic event processing computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of dynamic event processing computing platform 110 and/or by different computing devices that may form and/or otherwise make up dynamic event processing computing platform 110.

For example, memory 112 may have, store, and/or include an event processing request module 112a. Event processing request module 112a may store instructions and/or data that may cause or enable the dynamic event processing computing platform 110 to receive data associated with an event processing request (e.g., a request to process a transaction, or the like). The received data may include an amount associated with the event, identifying information associated with the device from which the request was received, identifying information associated with a user requesting the event, event details (e.g., retail establishment at which the event is being processed, and the like), calendar information associated with a user of the computing device, social media information of the user, and the like. The data may be received from, for example, a remote user computing device 170, 175, from a point of sale or other system associated with the entity at which the event is being processed, and the like.

Memory 112 may further have, store and/or include a data analysis module 112b. Data analysis module 112b may store instructions and/or data that may cause or enable the dynamic event processing computing platform 110 to analyze the data received from various sources (e.g., data received by event processing request module 112a). The data may be analyzed to extract data that may be used in making one or more determinations, identify a user and one or more associated potential sources for processing the event, and the like.

Memory 112 may further have, store, and/or include a location determination module 112c. The location determination module 112c may store instructions and/or data that may cause or enable the dynamic event processing computing platform 110 to receive, for example, global positioning system (GPS) data from a user device (e.g., remote user computing device 170, 175) at which the request to process the event is received. In some examples, the GPS data may include longitude and latitude coordinates for the computing device. The location determination module 112c may then identify a current location of the computing device and may use this location information in determining or identifying a source from which to process the event.

The dynamic event processing computing platform 110 may further have, store, and/or include a machine learning engine 112d and machine learning datasets 112e. Machine learning engine 112d and machine learning datasets 112e may store instructions and/or data that cause or enable dynamic event processing computing platform 110 to evaluate analyzed data and/or location data to identify a source from which to process an event. The machine learning datasets 112e may be generated based on analyzed data (e.g., data from previously received data, data from internal data computing device 120, data from external data computing device 130, and the like), raw data, and/or received from one or more outside sources.

The machine learning engine 112d may receive data (e.g., data from internal data computing device 130, external data computing device 130, analyzed data from data analysis module 112b, location data from location determination module 112c, and the like) and, using one or more machine learning algorithms, may generate one or more machine learning datasets 112e. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention. In some examples, the machine learning engine 112d may analyze data to identify patterns of activity, sequences of activity, and the like, to generate one or more machine learning datasets 112e.

The machine learning datasets 112e may include machine learning data linking one or more locations, types of events, users, dates, times, and the like, to a particular source. For instance, if a user has a corporate lunch at a particular location, the machine learning datasets 112e may link data associated with the time of day, particular location, and the like, to a corporate event and thus a corporate source for processing the event (e.g., an account issued by the corporate entity, enabled for use for processing certain corporate events, and the like). In another example, if a user meets his or her friend for lunch on the third Wednesday of the month, the machine learning datasets 112e may link information associated with the time of day, date, and the like, to a personal source (e.g., a personal account).

The machine learning datasets 112e may be updated and/or validated based on subsequent data received, for example, after a source is selected, event is processed, notification is generated, or the like.

The machine learning datasets 112e may be used by, for example, a source determination module 112f. Source determination module 112f may store instructions and/or data that may cause or enable the dynamic event processing computing platform 110 to identify, based on the one or more machine learning datasets, an appropriate source to be used in processing the event. In some examples, the source may be automatically used to process the event (e.g., without additional user input). In other examples, a request to confirm selection of the source may be transmitted to the user.

As discussed herein, the source may be selected based on historical linking data, current time, date, calendar information, social media information, location of a user, amount of event, type of event, and the like. Upon identifying or determining the source, the source determination module 112f may transmit a signal, instruction or command to an event processing module 112g. Event processing module 112g may store instructions and/or data that may cause or enable the dynamic event processing computing platform 110 to execute processing of the event. For instance, upon receiving the instruction, command or signal from the source determination module, the event processing module 112g may execute processing of the event, including adding an event amount to a balance associated with the source, withdrawing the event amount from the source, or the like.

Dynamic event processing computing platform 110 may further have, store and/or include a notification generation module 112h. Notification generation module 112h may store instructions and/or data that may cause or enable the dynamic event processing computing platform 110 to generate one or more notifications, transmit the notifications to one or more computing devices (e.g., remote user computing device 170, 175), and cause the notification to display on the computing device. For instance, the notification generation module 112h may generate a notification indicating a source used to process an event. In some examples, the notification may be transmitted after the event is processed and may include an option to select an alternate source, thereby voiding the original processing of the event and re-processing the event with the desired source.

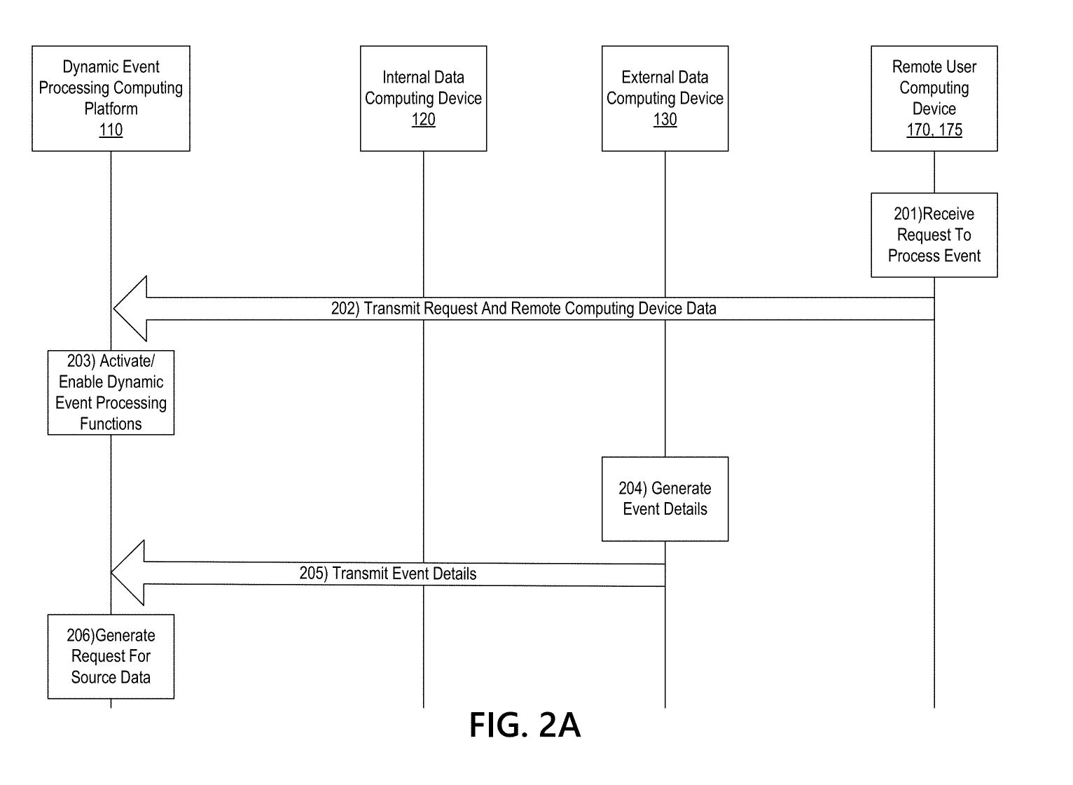

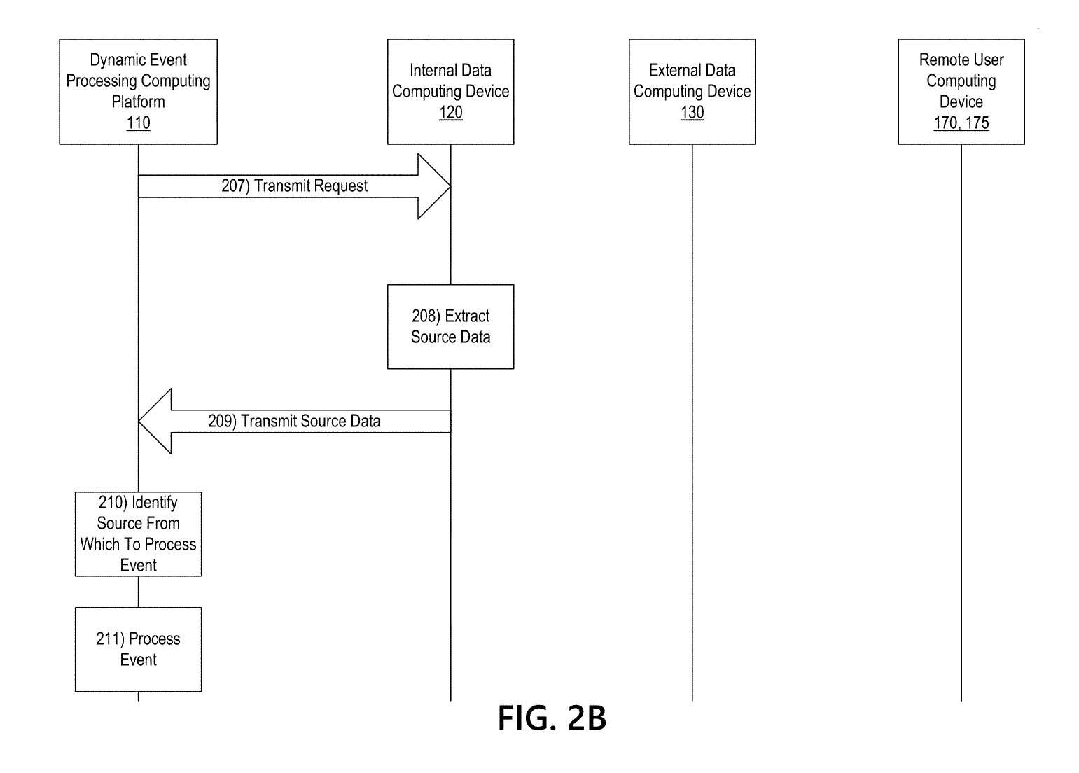

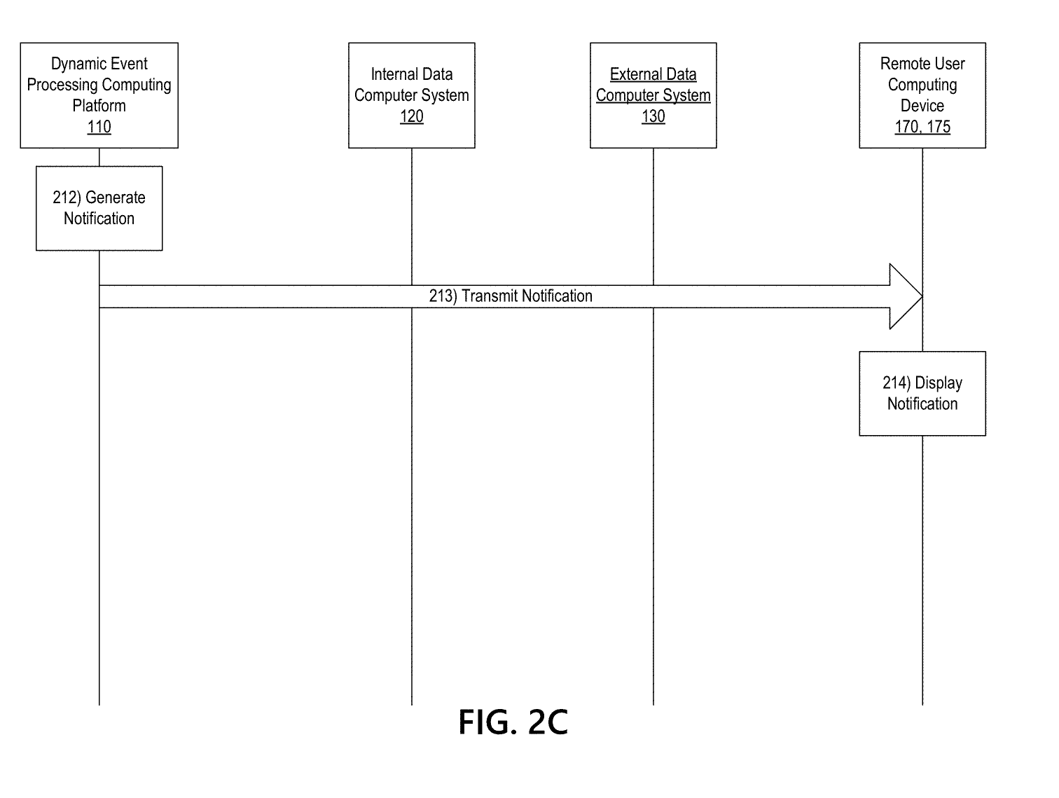

FIGS. 2A-2C depict an illustrative event sequence for implementing and using dynamic event processing functions in accordance with one or more aspects described herein. The events shown in the illustrative event sequence are merely one example sequence and additional events may be added, or events may be omitted, without departing from the invention.

Referring to FIG. 2A, at step 201, a request to process an event may be received by, for example, remote computing device 170 or 175. In some examples, the request to process the event may include a request to process an event via a mobile or online payment application executing on the remote computing device 170, 175. In some arrangements, the request to process the event may be generating using near-field communication between a mobile device of a user and a point-of-sale system of an entity. At step 202, the request to process the event, and addition data associated with the remote user computing device 170, 175, user, and the like, may be transmitted to the dynamic event processing computing platform 110. For instance, a unique identifier associated with the remote user computing device 170, 175, a name or other identifier associated with a user, and the like, may be transmitted with the request. In some examples, location information, such as GPS data, may be transmitted with the request to process the event. In some arrangements, one or more details of the event, such as amount, entity with whom the event will be processed, and the like, may be transmitted. In some examples, the additional data may include calendar data of the user received from a calendar application executing on the mobile device. Additionally or alternatively, social media data associated with the user may be received from one or more social media applications executing on the mobile device.

At step 203, the request and additional data may be received by the dynamic event processing computing platform 110 and, in response, one or more dynamic event processing functions may be activated and/or enabled. For instance, upon receipt of the request and/or the additional information, one or more functions for dynamically processing events may be transferred from a disabled or inactive state to an enabled or active state in order to perform the necessary dynamic event processing functions.

At step 204, one or more additional event details may be generated at, for example, external data computing device 130. For instance, external data computing device 130 may be, for example, a computing device associated with the entity at which the event is being processed. In some examples, external data computing device 130 may include a point-of-sale system at the entity. Accordingly, one or more event details (e.g., amount or amount verification, type of event, processing system, and the like) may be generated by the external data computing device 130. At step 205, the additional event details may be transmitted to the dynamic event processing computing platform 110.

At step 206, a request for source data may be generated. For instance, based on the user identifier, computing device identifier, additional information associated with the event, device, or the like, the dynamic event processing computing platform 110 may identify a user associated with the event or requesting processing of the event. Based on this user information, the dynamic event processing computing platform 110 may transmit a request for potential sources (e.g., accounts) associated with the user or computing device from which to process the event.

With reference to FIG. 2B, at step 207, the request for source data may be transmitted to, for instance, internal data computing device 120. In some examples, internal data computing device 120 may store or include user information, source information (e.g., account numbers, contact information, and the like), and the like. The request for source data may include a name or other identifier of the user or computing device that may be used as input in a database query to obtain the potential source information.

At step 208, potential source data may be extracted. For instance, source data matching or associated with the user or device from which the request to process an event was received may be identified and extracted. In step 209, the extracted source data may be transmitted to the dynamic event processing computing platform 110.

At step 210, one or more machine learning datasets may be used to identify a source from which to process the event. For instance, the one or more machine learning datasets may be used to identify one or more sources to be used in event processing based on, for example, the user request, the additional data received (e.g., location information, time, day, date, or the like), additional event details received (e.g., amount, type of event, and the like). In some examples, the machine learning datasets may be used to identify one or more of a personal data source or a business data source from which to process the event.

At step 211, the event may be processed. In some examples, prior to processing the event from the identified source, user input may be requested confirming that the event should be processed from the identified source. In other examples, the system may automatically process the event using the identified source (e.g., without any user input confirming the identified source should be used).

With reference to FIG. 2C, at step 212, a notification may be generated. The notification may include an indication that the event has been processed. In some arrangements the notification may include identification of the source used to process the event, event details, and the like. At step 213, the notification may be transmitted from the dynamic event processing computing platform 110 to the remote user computing device 170, 175 (e.g., the user computing device being used to process the event, from which the event processing request was received, or the like). In step 214, the notification may be displayed on the remote user computing device 170, 175. For instance, transmission of the notification may include an instruction, command or signal which, when executed by the remote user computing device 170, 175, may cause the notification to be displayed on a display of the remote user computing device 170, 175.

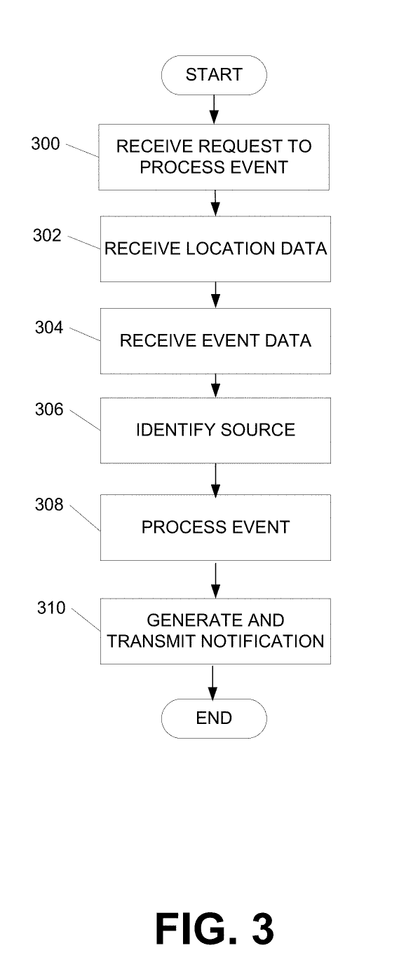

FIG. 3 is a flow chart illustrating one example method of implementing a machine learning system for dynamically processing events according to one or more aspects described herein. The processes illustrated in FIG. 3 are merely some example processes and functions. The steps shown may be performed in a different order, more steps may be added, or one or more steps may be omitted without departing from the invention.

In step 300, a request to process an event may be received. In some examples, the request may be received from a user device, such as a mobile device, wearable device, or the like, of a user, executing an application to process events. In some examples, receiving the request to process the event may including receiving additional information.

In step 302, location data may be received. For example, GPS or other location data may be received from the user device. In step 304, additional event data may be received. For example, event details such as type of event, amount of event, parties to the event, and the like, may be received.

In step 306, one or more machine learning datasets may be used to identify a source for use in processing the event. For instance, based on the received request, location data, and/or additional event data, the one or more machine learning datasets may be used to identify a source, from a plurality of sources associated with a user, from which to process the event.

In step 308, the event may be processed. In some examples, processing the event maybe performed automatically upon identifying a source for use in processing the event (e.g., without user interaction). In other examples, a request for user input confirming use of the identified source may be received prior to processing the event.

In step 310, a notification may be generated and transmitted to, for example, the user device. For instance, a notification including an indication that the event was processed, an identified source used to process the event, event details, and the like may be generated and transmitted to the user device. The notification may be displayed on the user device.

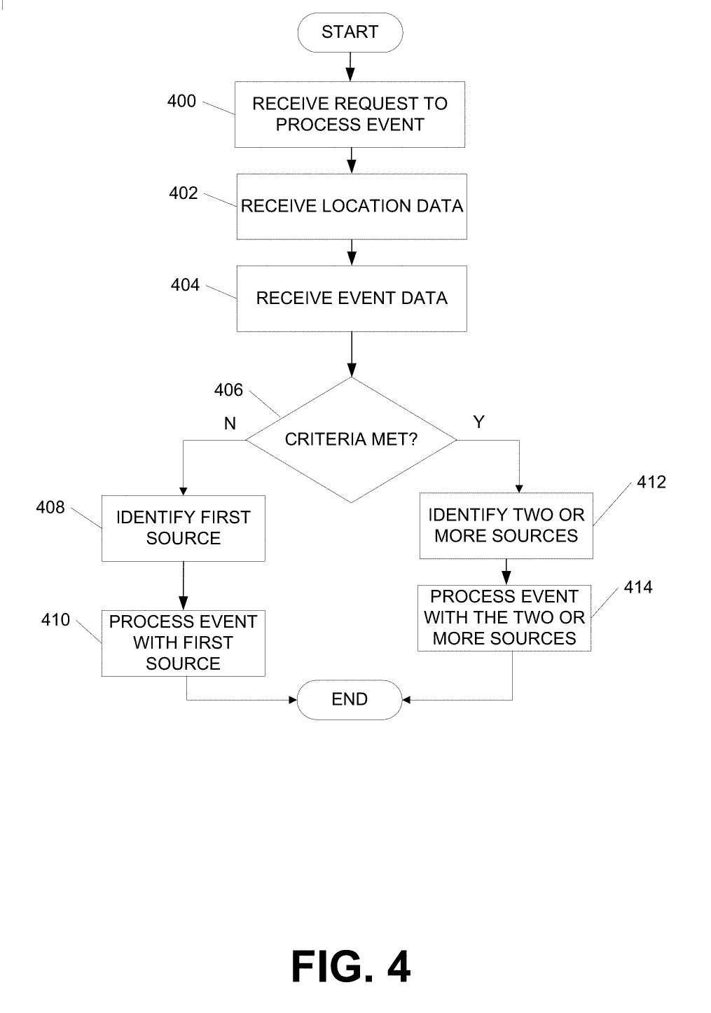

FIG. 4 illustrates is a flow chart illustrating another example method of implementing a machine learning system for dynamically processing events according to one or more aspects described herein. The processes illustrated in FIG. 4 are merely some example processes and functions. The steps shown may be performed in a different order, more steps may be added, or one or more steps may be omitted without departing from the invention.

In step 400, a request to process an event may be received. In some examples, the request may be received from a user device, such as a mobile device, wearable device, or the like, of a user, executing an application to process events. In some examples, receiving the request to process the event may including receiving additional information.

In step 402, location data may be received. For example, GPS or other location data may be received from the user device. In step 404, additional event data may be received. For example, event details such as type of event, amount of event, parties to the event, and the like, may be received.

In step 406, a determination may be made as to whether one or more criteria are met. For example, one or more machine learning datasets may be used to evaluate the received location data, event data, and the like, to determine whether one or more criteria are met. For instance, the machine learning datasets may be used to evaluate whether an amount of the event is over a daily, monthly, weekly, or the like, limit for a particular source (e.g., a per diem amount provided by a business providing a limit to an amount that can be charged per day, week, month, or the like, to the business account). In another example, details of the event being processed may be evaluated to determine whether a portion of the event is directed to a business expense while a portion is directed to a personal expense. Various other criteria may be evaluated without departing from the invention.

If, in step 406, a determination is made that the one or more criteria are not met, a first source for processing the event may be identified in step 408. For instance, based on the received request, location data, and/or additional event data, as well as the one or more machine learning datasets, a first source from which to process the event may be identified. In step 410, the event may be processed with or from the identified first source.

If, in step 406, a determination is made that one or more criteria are met, two or more sources may be identified for processing the event in step 412. For instance, based on the received request, location data, and/or additional event data, as well as the one or more machine learning datasets, two or more sources from which to process the event may be identified. In some examples, identifying two or more sources may include allocating a portion of the event to each source for processing (e.g., business expenses to the business source, personal expenses to the personal source, or the like). In step 414, the event may be processed with or from the identified two or more sources.

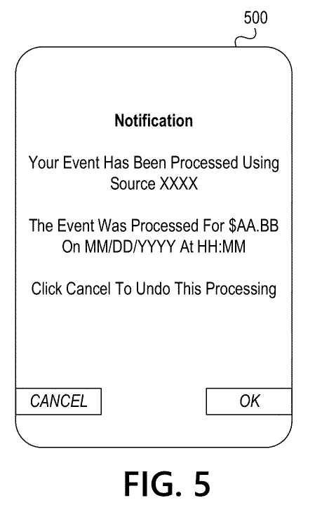

FIG. 5 illustrates one example user interface that may be generated in accordance with one or more aspects described herein. The interface 500 may include an indication that an event was processed, a source from which the event was processed and/or additional event details. In some examples, the notification may include an option to undo the processing of the event. Accordingly, the user interface may provide a “Cancel” option which may void the event processed and may cause additional notifications to be generated.

As discussed herein, the arrangements described provide for use of machine learning datasets to identify one or more sources to provide dynamic event processing functions. As discussed herein, the arrangement provide for accurate and efficient determination of one or more appropriate sources for use in processing an event, for efficiently processing events using multiple sources, and the like. The functions provided herein may be performed in real-time or near real-time in order to enable dynamic event processing.

In some examples, the arrangements described herein may be used to efficiently identify a business or personal account for use in processing an event. For instance, if a user is at a particular location during business hours, based on one or more machine learning datasets, the system may determine that the expense associated with the visit to the location is a business expense and may use a business account (e.g., credit account, debit account, or the like) to process the event. In another example, if a user is requesting to process an event outside of business hours, it is likely a personal expense and the system may identify a personal account (e.g., credit account, debit account, or the like) to process the event.

In some examples, computing devices associated with other known users and within a predefined proximity of the mobile device from which the request to process the event was received may be used to identify an appropriate source. For instance, if, based on, for example, GPS data, near-field communications, or the like, one or more mobile devices associated with one or more co-workers are within a predefined proximity of the user's mobile device, the one or more machine learning datasets may identify a business source for use in processing the event. Alternatively, if the mobile devices within the predefined proximity are associated with family members of the user, the system may identify a personal source for use in processing an event.

In still other examples, data associated with travel of a user (e.g., social media data, calendar data, email traffic, and the like) may indicate that a user is on a business trip. Accordingly, events requested while it is detected that the user is on the trip may be processed using the business source. In some examples, the machine learning datasets may use predefined limits (e.g., per diem spending limits) to identify a portion of an event that may be processed using the business source and a portion of the event (e.g., an amount over the per diem amount) that may be processed using the personal source.

In some examples, the system may also track progress toward, for example, a per diem spending limit and may generate and transmit a notification to a user as the user's spending approaches the limit. The system may also track events processed and may notify a user when a receipt will be needed (e.g., for reimbursement purposes), and the like. The system may also track one or more expenses for ease in building an expense report for reimbursement, for providing audit data as requested, and the like.

In some examples, the system may detect that a personal event is being processed while, for example, on a business trip (e.g., a user may be at an establishment for which business expenses are not approved). Accordingly, the user may process any events using a personal source and/or may mask the data associated with the outing (e.g., by providing a label for the data, expense, or the like) that does not provide specific information in an effort to maintain privacy of the user.

As discussed herein, in some examples, the system may automatically process the event using the identified source (e.g., without user interaction). In other arrangements, user input confirming a source and/or authorizing processing the event may be received prior to processing the event. In some examples, one or more tiers for processing the event may be established. For instance, if an amount of an event is below a first threshold, it may be automatically processed (e.g., without user interaction. If an amount of an event is greater than a first threshold but less than a second threshold, it may require that a notification be transmitted to the user and a user may either respond to the notification or, after a pre-determined time period has elapsed, the event may be processed. If an amount is greater than the second threshold, user authorization or approval may be required prior to processing the event.

In some examples, user approval may be requested for a first event processed at a particular location, time, day, or the like. However, any subsequent requests for event processing at a same or similar location, time and/or day may be automatically processed (e.g., without user approval or interaction). In some arrangements, the number of times user approval or input may be requested may be customized by the user. This data associated with user approvals may then be used to update and/or validate the one or more machine learning datasets.

In some arrangements, the system may aggregate data from a plurality of users when making decisions. For instance, if a plurality of users are in a similar location (e.g., a first business location) and are travelling to same second business location, the system may generate a notification suggesting sharing of a cab and may process the event across the multiple sources associated with the plurality of users.

In some examples, a virtual event processing device may be generated and transmitted to multiple users (e.g., multiple users going on a business trip). The virtual event processing device may be linked to a single business source for event processing. Accordingly, all expenses for the trip may be processed from the single business source when a business source is identified for processing, and from the individual personal source of each user when a personal source is identified.

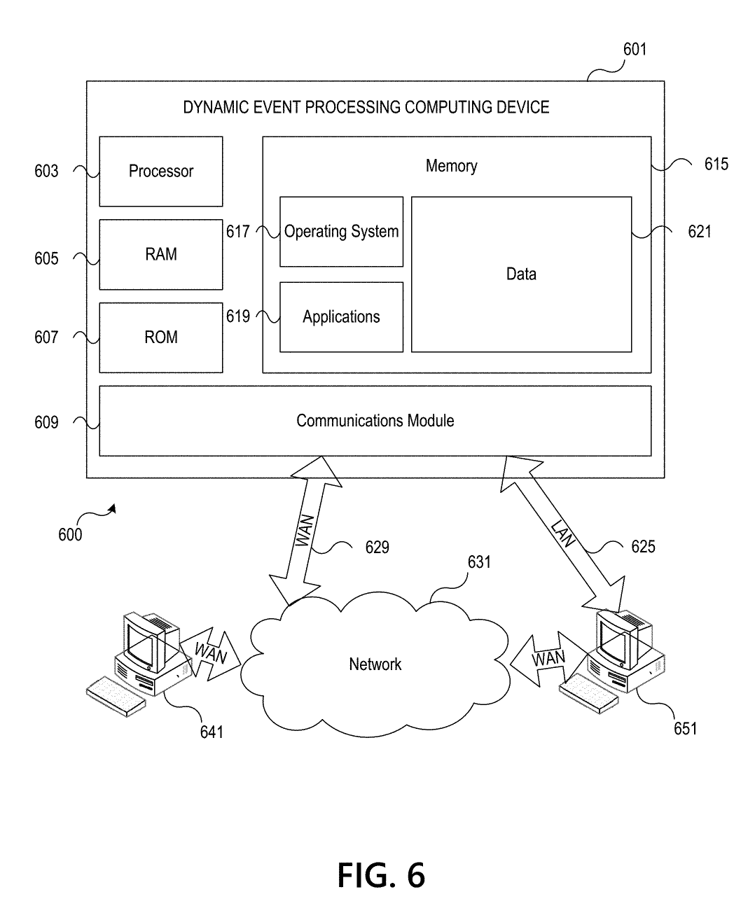

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include dynamic event processing computing device 601 having processor 603 for controlling overall operation of dynamic event processing computing device 601 and its associated components, including Random Access Memory (RAM) 605, Read-Only Memory (ROM) 607, communications module 609, and memory 615. Dynamic event processing computing device 601 may include a variety of computer readable media. Computer readable media may be any available media that may be accessed by dynamic event processing computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on dynamic event processing computing device 601. Such a processor may execute computer-executable instructions stored on a computer-readable medium.

Software may be stored within memory 615 and/or storage to provide instructions to processor 603 for enabling dynamic event processing computing device 601 to perform various functions as discussed herein. For example, memory 615 may store software used by dynamic event processing computing device 601, such as operating system 617, application programs 619, and associated database 621. Also, some or all of the computer executable instructions for dynamic event processing computing device 601 may be embodied in hardware or firmware. Although not shown, RAM 605 may include one or more applications representing the application data stored in RAM 605 while dynamic event processing computing device 601 is on and corresponding software applications (e.g., software tasks) are running on dynamic event processing computing device 601.

Communications module 609 may include a microphone, keypad, touch screen, and/or stylus through which a user of dynamic event processing computing device 601 may provide input, and may also include one or more of a speaker for providing audio output and a video display device for providing textual, audiovisual and/or graphical output. Computing system environment 600 may also include optical scanners (not shown).

Dynamic event processing computing device 601 may operate in a networked environment supporting connections to one or more remote computing devices, such as computing devices 641 and 651. Computing devices 641 and 651 may be personal computing devices or servers that include any or all of the elements described above relative to dynamic event processing computing device 601.

The network connections depicted in FIG. 6 may include Local Area Network (LAN) 625 and Wide Area Network (WAN) 629, as well as other networks. When used in a LAN networking environment, dynamic event processing computing device 601 may be connected to LAN 625 through a network interface or adapter in communications module 609. When used in a WAN networking environment, dynamic event processing computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like and are configured to perform the functions described herein.

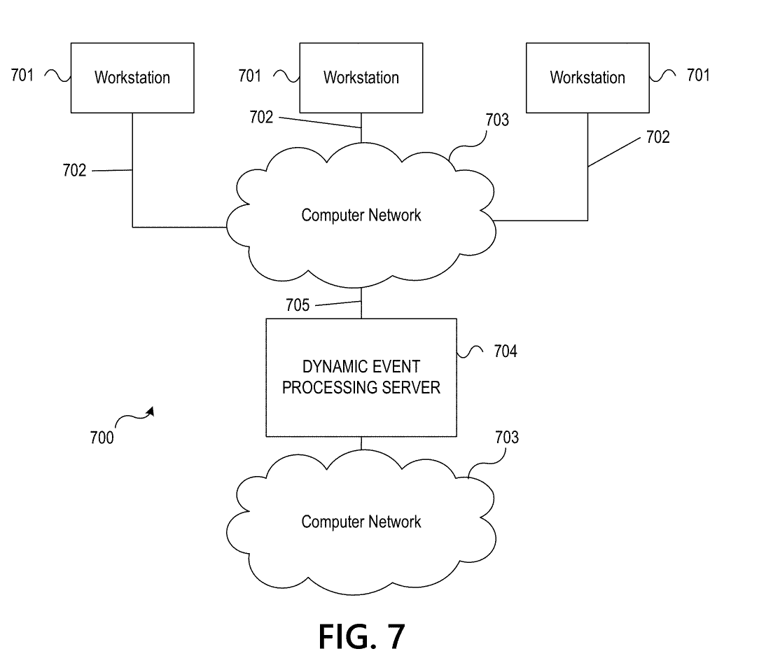

FIG. 7 depicts an illustrative block diagram of workstations and servers that may be used to implement the processes and functions of certain aspects of the present disclosure in accordance with one or more example embodiments. Referring to FIG. 7, illustrative system 700 may be used for implementing example embodiments according to the present disclosure. As illustrated, system 700 may include one or more workstation computers 701. Workstation 701 may be, for example, a desktop computer, a smartphone, a wireless device, a tablet computer, a laptop computer, and the like, configured to perform various processes described herein. Workstations 701 may be local or remote, and may be connected by one of communications links 702 to computer network 703 that is linked via communications link 705 to dynamic event processing server 704. In system 700, dynamic event processing server 704 may be a server, processor, computer, or data processing device, or combination of the same, configured to perform the functions and/or processes described herein. Server 704 may be used to receive requests to process events, receive additional data, identify a source from which to process the event, process the event, generate and transmit notifications, and the like.

Computer network 703 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 702 and 705 may be communications links suitable for communicating between workstations 701 and dynamic event processing server 704, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A dynamic event processing computing platform, comprising:
at least one processor;
a communication interface communicatively coupled to the at least one processor; and
memory storing computer-readable instructions that, when executed by the at least one processor, cause the dynamic event processing computing platform to:
receive a request to process an event from a mobile device of a user;
responsive to receiving the request to process the event, enable dynamic event processing functions;
receive first data associated with a location of the mobile device of the user from which the request to process the event was received;
receive second data including event details;
identify, based on the first data, the second data, and one or more machine learning datasets, a first source from which to process the event; and
process the event using the identified first source.

2. The dynamic event processing computing platform of claim 1, wherein the first data associated with the location of the mobile device of the user includes global positioning system (GPS) data from the mobile device.

3. The dynamic event processing computing platform of claim 1, wherein the mobile device is a wearable device.

4. The dynamic event processing computing platform of claim 1, wherein the request to process the event is received from a mobile event processing application executing on the mobile device.

5. The dynamic event processing computing platform of claim 1, wherein the identified first source is one of: a business source associated with an entity and a personal source associated with the user.

6. The dynamic event processing computing platform of claim 1, wherein the request to process the event is generated via near-field communication between the mobile device and a point-of-sale system of an entity.

7. The dynamic event processing computing platform of claim 1, further including instructions that, when executed, cause the dynamic event processing computing platform to:
receive third data including calendar data associated with the user, and
wherein identifying the first source from which to process the event is further based on the third data.

8. The dynamic event processing computing platform of claim 1, further including instructions that, when executed, cause the dynamic event processing computing platform to:
determine, based on the one or more machine learning datasets, whether one or more criteria are met;
responsive to determining that the one or more criteria are met, identifying, based on the first data, the second data, and one or more machine learning datasets, at least a second source from which to process the event; and
process the event using the first source and the at least a second source.

9. A method, comprising:
at a computing platform comprising at least one processor, memory, and a communication interface:
receiving, by the at least one processor and via the communication interface, a request to process an event from a mobile device of a user;
responsive to receiving the request to process the event, enabling, by the at least one processor, dynamic event processing functions;
receiving, by the at least one processor and via the communication interface, first data associated with a location of the mobile device of the user from which the request to process the event was received;
receiving, by the at least one processor and via the communication interface, second data including event details;
identifying, by the at least one processor and based on the first data, the second data, and one or more machine learning datasets, a first source from which to process the event; and
processing, by the at least one processor, the event using the identified first source.

10. The method of claim 9, wherein the first data associated with the location of the mobile device of the user includes global positioning system (GPS) data from the mobile device.

11. The method of claim 9, wherein the mobile device is a wearable device.

12. The method of claim 9, wherein the request to process the event is received from a mobile event processing application executing on the mobile device.

13. The method of claim 9, wherein the identified first source is one of: a business source associated with an entity and a personal source associated with the user.

14. The method of claim 9, wherein the request to process the event is generated via near-field communication between the mobile device and a point-of-sale system of an entity.

15. The method of claim 9, further including:
receiving, by the at least one processor and via the communication interface, third data including calendar data associated with the user, and
wherein identifying the first source from which to process the event is further based on the third data.

16. The method of claim 9, further including:
determining, by the at least one processor and based on the one or more machine learning datasets, whether one or more criteria are met;
responsive to determining that the one or more criteria are met, identifying, by the at least one processor and based on the first data, the second data, and one or more machine learning datasets, at least a second source from which to process the event; and
processing, by the at least one processor, the event using the first source and the at least a second source.

17. One or more non-transitory computer-readable media storing instructions that, when executed by a computing platform comprising at least one processor, memory, and a communication interface, cause the computing platform to:
receive a request to process an event from a mobile device of a user;
responsive to receiving the request to process the event, enable dynamic event processing functions;
receive first data associated with a location of the mobile device of the user from which the request to process the event was received;
receive second data including event details;
identify, based on the first data, the second data, and one or more machine learning datasets, a first source from which to process the event; and
processing the event using the identified first source.

18. The one or more non-transitory computer-readable media of claim 17, wherein the first data associated with the location of the mobile device of the user includes global positioning system (GPS) data from the mobile device.

19. The one or more non-transitory computer-readable media of claim 17, wherein the mobile device is a wearable device.

20. The one or more non-transitory computer-readable media of claim 17, wherein the request to process the event is received from a mobile event processing application executing on the mobile device.

21. The one or more non-transitory computer-readable media of claim 17, wherein the identified first source is one of: a business source associated with an entity and a personal source associated with the user.

22. The one or more non-transitory computer-readable media of claim 17, wherein the request to process the event is generated via near-field communication between the mobile device and a point-of-sale system of an entity.

23. The one or more non-transitory computer-readable media of claim 17, further including instructions that, when executed, cause the computing platform to:
receive third data including calendar data associated with the user, and
wherein identifying the first source from which to process the event is further based on the third data.

24. The one or more non-transitory computer-readable media of claim 17, further including instructions that, when executed, cause the computing platform to:
determine, based on the one or more machine learning datasets, whether one or more criteria are met;
responsive to determining that the one or more criteria are met, identifying, based on the first data, the second data, and one or more machine learning datasets, at least a second source from which to process the event; and
process the event using the first source and the at least a second source.
